(19) United States
(12) Patent Application Publication
(10) Pub. No.: US 2009/0199507 A1
(43) Pub. Date: Aug. 13, 2009

(54) Methods and apparatus relating to customized parts

(76) Inventors: Dave Winter, Mountain View, CA (US); Michael McElroy, Los Altos, CA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/284,689

(22) Filed: Sep. 23, 2008

Related U.S. Application Data
(60) Provisional application No. 61/065,409, filed on Feb. 11, 2008.
(60) Provisional application No. 61/028,495, filed on Feb. 13, 2008.

(51) Int. Cl. E06B 1/52

(52) U.S. Cl. 52/745.15

(57) ABSTRACT

Methods and apparatus for replacing components, including doors, may include measuring devices, measurement processing steps, component cutting steps, painting and installation steps. Components to be replaced, such as doors, may be measured while still installed and the measurements directed to dimensions and components of the door frame rather than the dimensions of the door.

This application claims benefit of U.S. Provisional Patent Applications Ser. No. 60/994,758, filed on Sep. 20, 2007, Ser. No. 61/028,495 filed on Feb. 13, 2008, and Ser. No. 61/065,409 filed on Feb. 11, 2008, each of which is expressly incorporated by reference in its entirety into this application.

### FIELD OF THE INVENTION

Embodiments of the present invention provide methods of and devices for fitting, manufacturing and supplying custom parts to various applications. Some embodiments of the present invention are particularly adapted for use in the replacement door industry.

### BACKGROUND OF THE INVENTION

Prior art component manufacturing and/or replacement systems are limited in many regards. In the replacement door field, prior art systems required that a door to be replaced be removed from the doorframe to which it is mounted by hinge systems. That remove door typically is used as a template for cutting the size of the new replacement door and for positioning the various components necessary on the new door. These new components include hinges, door latches, doorknobs as well as other devices. In contrast to these devices, systems and methods of the present invention is prior art systems are severely limited.

### BRIEF DESCRIPTION OF THE DRAWINGS

Aspects of the inventions herein are described in greater detail by reference to the attached drawings. It is to be understood that the particular need of the drawings does not supersede the generality of the descriptions herein of the inventions described and claimed herein.

FIG. 1 illustrates for typical doorframe scenarios.

FIG. 1A is a representation of a typical doorframe.

FIG. 1B is a representation of a common doorframe problem where one side is bowed in one direction from perpendicular.

FIG. 1C is a representation of the doorframe wherein the strike side of the door is bowed inwards.

FIG. 1D represents a doorframe scenario where the top portion of the frame is not horizontal.

FIG. 2 shows an exemplary measuring device positioned and operational distance from a doorframe.

FIG. 3 illustrates steps in measurement, processing, machining and installation of the present inventions.

FIG. 4 illustrates an alternate method for measuring aspects of the doorframe.

FIG. 5 shows a device for use by measuring operators for use in assisting measurements.

### DETAILED DESCRIPTION

Embodiments of the present invention provide methods of and devices for fitting, manufacturing and supplying custom parts to various applications. Some embodiments of the present invention are particularly adapted for use in the replacement door industry.

Embodiments of the present invention include systems and processes for measuring, analyzing and evaluating door openings and related door apparatus and hardware, methods and systems for evaluating, processing and adapting door opening and apparatus measurement, systems for checking door system stock products for appropriateness in proposed door replacement instances, systems and methods for custom cutting door products, systems and methods for painting doors, systems and methods for replacing doors, methods of doing business, including particularly with regard to the businesses of selling, measuring, manufacturing, delivering and installing replacement doors in both residential and commercial settings.

Embodiments of the present invention may also comprise novel apparatus and methods for measuring geometry in certain aspects of doors and door frames, novel methods and systems for matching products to proposed door applications and for checking the compatibility of stock doors for particular door applications.

In many instances it is desirable to provide systems and methods for replacing doors in existing door frames. Frequently the door frames in existing buildings are not perfectly rectangular or straight sided. Also, the hinges and or latch points in the door frames frequently are not ideally positioned. It is often desirable to replace doors in existing door frames by using what is termed “slab” doors. Since slab doors typically will be virtually rectangular with straight sides, these doors often will not readily fit in existing door frames. Additionally slab doors are usually not the correct size for existing door openings and typically must be cut down to fit in a particular doorframe application. Additional difficulties are presented when the installer of the slab doors attempts to make the necessary cuts into the door for receiving the existing hinge assembly of the doorframe, the hinge mortise. Further difficulties are presented to the installer in trying to appropriately cut the door handle hole (lock bore), and latch receiver portions in the slab door (latch mortise).

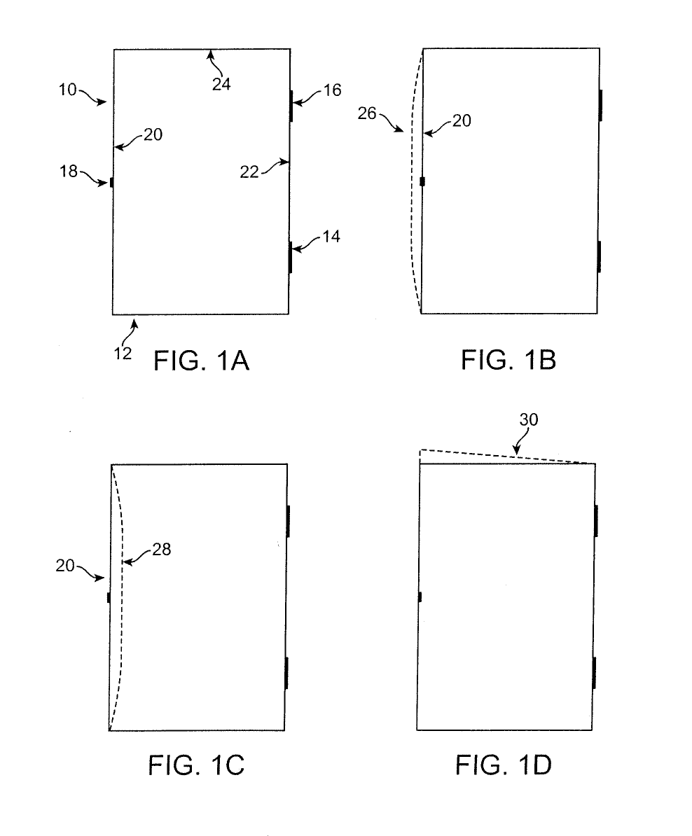

The irregularities of doorframes present particular problems to an installer attempting to replace doors for the doorframes. Shown in FIG. 1 are four representations of door frames. These four representations illustrate some common problems in fitting replacement doors to existing door frames. Show it FIG. 1 a is a typical doorframe 10. Also shown is a floor portion 12 of the frame. Also shown are hinges 14 and 16 and door latch hole 18. Also shown are a side portion of the frame 20 designated the strike side of the frame, another side of the frame 22 designated the hinge side of the frame and the top portion of the frame 24.

FIG. 1B represents a common doorframe problem where one side of the frame is not perpendicular and straight but rather is bowed in one direction from perpendicular. In FIG. 1B. the strike side of the frame 20 is shown to be bowed outwards and represented by dotted line 26.

FIG. 1C represents a problem similar to that of one B. but where in the strike side of the door 20 is bowed inwards such as is shown at dotted line 28.

While the door frames of FIGS. 1B and 1C are exemplars it should be understood also that the bowed portion of the sides of the doorframe may also occur on the hinge side of the frame.

FIG. 1D represents a situation where the top portion of the frame 24 is not horizontal or does not form a perpendicular angle with both of the sides of the doorframe. Instead as shown in FIG. 1D the top portion of the doorframe may be at an angle (see, as represented by dotted line 30) other than perpendicular in relation to each of the sides of the frame. Additionally the top portion of the frame may be bowed (either to the inside or outside of horizontal) as shown for the sides of the doorframe in FIGS. 1B and 1C.

Aspects of certain embodiments of the present invention solve many of the difficulties heretofore faced by those attempting to replace existing doors. Embodiments of the present invention may include a device that measures the shape of a doorframe as well as the precise location of the hinge assemblies, the latch hole in each doorframe as well as other hardware or features.

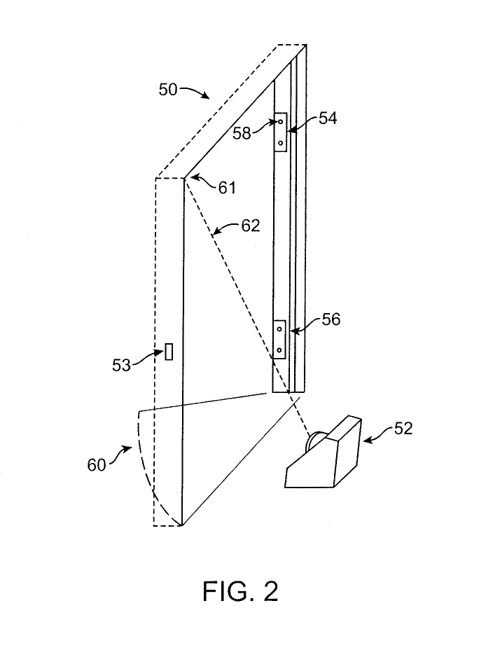

FIG. 2 shows an exemplary device 52 positioned an operational distance from a door frame 50. Also shown in the doorframe are hinges 54 and 56, and door latch receiver 53. Also shown that 60 is the arc of the door as it travels (the doors not shown). Shown at him 58 is the head of one of the screws on the hinge assembly affixed to the doorframe 50. Measuring device 52 is shown measuring the distance and angle of orientation 62 from the measuring device 52 to an upper corner of the doorframe 61. An operator using measuring device 52 can be prompted to measure the distance and angle of orientation to multiple points on the doorframe as well as multiple hardware points on the doorframe.

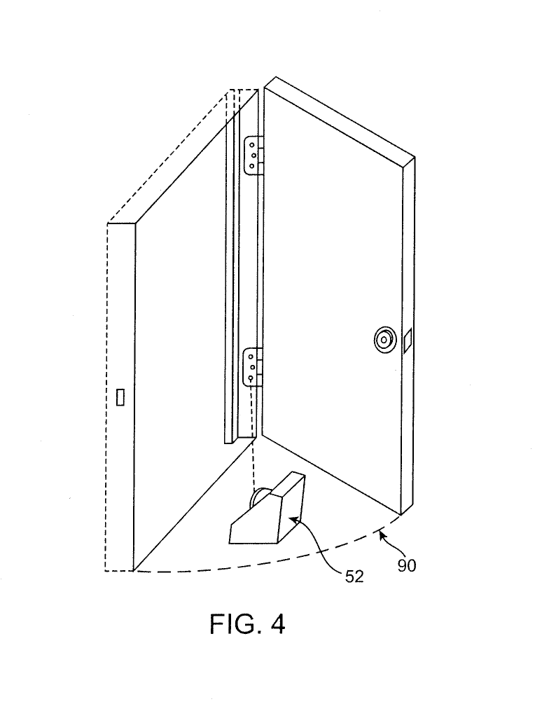

In the example shown in FIG. 2, the measuring device 52 is shown positioned outside the plane of the doorframe. In certain embodiments of the present invention a measuring device may alternatively be placed in, approximately in, or particularly near, the plane of the points to be measured on the doorframe. In other embodiments of the measuring device may be positioned as shown in FIG. 4.

In certain embodiments of the present invention the device stores data representing the shape and/or dimensions of the doorframe and the locations of the hinge assemblies and latch hole as well as other information in electronic form. The electronic data relating to the doorframe is transmitted to a processing unit which generates cutting data for a CNC (computer numerical control) machine. The CNC machine can then cut the appropriate door slab to precisely match or custom match the doorframe. In certain embodiments automated painting apparatus is also supplied so that in a completely automated electronic data relating to a doorframe can be received, processed, and appropriate door slab (or preselected doorstop) can be retrieved and processed in the CNC machine, and then the custom cut door can be automatically painted to the custom selected color for the particular installation.

The data from the measuring device 52 can be transmitted to the processing unit by a variety of methods. The measuring device itself can be connected to the processing unit, or the data from the measuring device can be read onto a memory unit which can be connected to the processing unit or, in some embodiments, the data from the measuring device can be transmitted to the processing unit by Internet, wireless or other transmission techniques. Transmission by methods such as via the Internet allows a widely distributed network of used measurement devices with a central processing unit that receives data from a variety and plurality of measuring devices. In some embodiments the central processing operation can then retransmit CNC cutting directions to one or a plurality of CNC cutting operations distributed either adjacent to or far from the processing unit. In such an embodiment a single, or relatively few number of, processing units can support a large plurality of measurement devices and a large plurality of distributed CNC door cutting operations. Additionally a centralized processing unit can provide support for a business method that includes attachment of royalty payments each time data from a major doorframe is processed. The processing could include not only the geographical location of the major doorframe, but the type and model of door slab to be used, the particular vendor providing the measurement operation, the particular vendor providing the CNC cutting operation, and the particular vendor providing the installation operations. Each of these data aspects can be utilized in attaching different royalty factors such as in franchised operations where each step of sales, measurement, processing, CNC cutting (or other cutting), painting, delivery, and installation may be carried out by a separate or unitary franchisee. Additionally a plurality of the preceding steps may be accomplished by a single franchisee while separate others of the prior steps may be accomplished by a second franchisee or a plurality of additional franchisees. Separate royalty payments may be factored due to geographical location of measure doorframes, source of door slab used for the replacement door, quality and or type of door slab used in the replacement, special tooling and/or cutting on the particular door slab, painting aspects of the particular door slab, aspects of the installation of the door, and identity or characteristics of particular franchisees involved in the steps of the replacement of the door. By providing a centralized processing operation for all measurement devices and all the CNC cutting operations a licensor of the methods herein can control and monitor all royalty payments, all door replacements and all operations pursuant to aspects of the present inventions. Furthermore, to facilitate these methods, the data from the measurement devices can be specially encrypted or configured in such a way as to only be usable by a licensed central processing unit. Furthermore the instructions for CNC operations can also be encrypted or specially adapted to only be usable at CNC operations licensed pursuant to methods of the present invention.

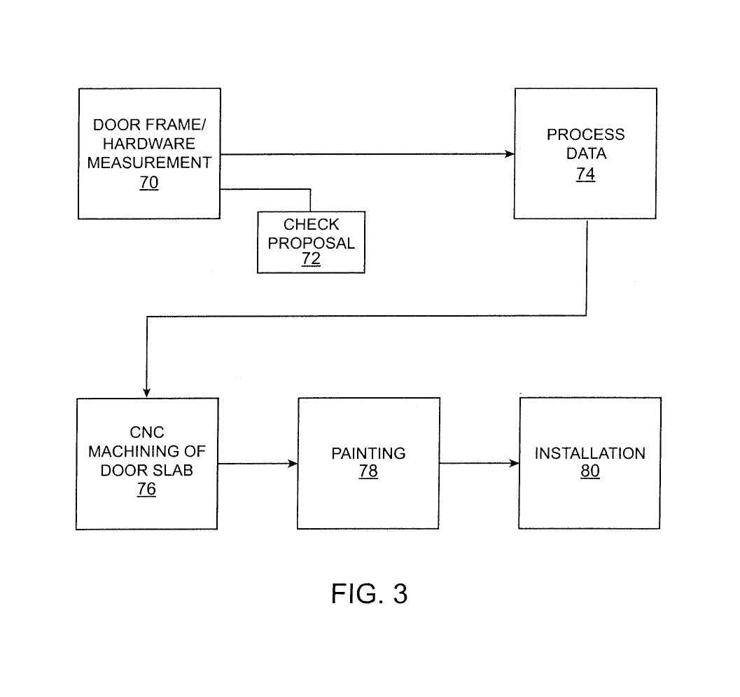

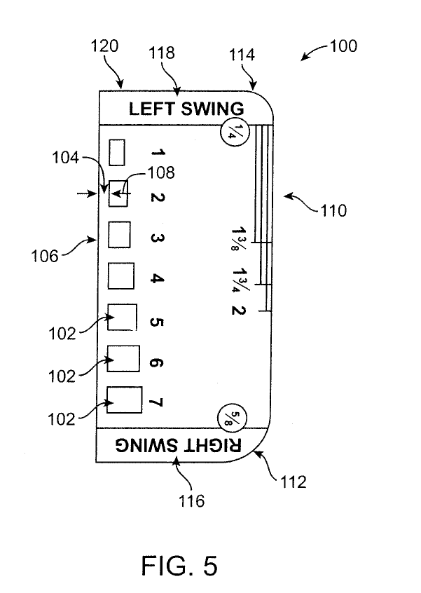

The just described process is illustrated in FIG. 3. FIG. 3 shows a first step 70 of the measurement of the doorframe and associated hardware. During this step additional checks can be accomplished 72. Such checks can include a number of matters such as comparing the measured geometry of the doorframe with data stored in the measuring device representing and associated with proposed door slabs for the particular installation. If, for example, trying to fit a proposed door slab into an identified and measured doorframe would result in excessive reduction in the peripheral substance of the door slab, frequently referred to as “rails”, (such as would possibly weaken the structure of the door slab) the measuring device can alert the operator to notify him or her that the proposed lab would be not recommended for the proposed installation. At that point the operator can resolve this issue with the entity seeking to replace the door. Resolution may include selection of a different style, size, or model of door slab. Additionally during this step, the operator conducting the measurement of the doorframe can input the hinge type as well as the backset of the hinge from the doorstop. The backset as referred to herein typically refers to the distance on the doorframe between the edge of the backstop and the nearest edge of the hinge plate attached to the doorframe. Typical hinge designs are selected from a few standard designs. Some hinges have three, four, five, or six screws per plate. Some hinges have square corners some hinges have rounded corners. Hinges having rounded corners typically have either a ¼″ radius or ⅝″ radius curve on the corners. Additionally, hinges typically are of certain preset sizes. In accordance with certain embodiments of the present invention it is valuable for the operator of the measurement device to input these aspects of the particular hinge. Additionally it is important that the measuring device either ascertained by the steps of measurement or by operator input whether the door is a type designated a “left swing” or a “right swing” door. For purposes herein a “right swing” door will be seen as a door configured such that when it is opened away from an individual standing facing the doorframe, the hinges of the doorframe will be on the side of the doorframe to the individual's right hand side. A “left swing” door will have the hinges on the opposite side (i.e., left side) of the doorframe when the individual facing the door opens the door away from the him or her self. It is also useful in certain aspects of the present invention to note or to have input to the measuring device the thickness of the existing door. Typically many doors are either 1⅜″ thick, 1¾″ thick or 2 inches thick. A device particularly configured to assist the measuring operator in the collection, identification and input of many of these aspects is shown in conjunction with FIG. 5 herein.

In some embodiments the measuring device can include data relating to potentially available door slabs. For example, various available door slabs have a variety of available sizes, thicknesses, thicknesses of frame rails, size and location of door handle blocks, size and location of design features on the face of the door (such as a plurality of panels of various sizes on the face of the door slab). Each model of these various stores will have different characteristics as to what type of doorframe or frame environment it can fit. Once the doorframe has been measured the measuring device can prompt the operator with suggestions of proposed door slabs that would be appropriate for the measured opening. This provides a significant benefit in the sales cycle of replacement doors by allowing the purchaser to make a decision based on actual measurements and data as to which doors are indeed available and appropriate for the measured openings. In some embodiments, if the potential purchaser of the replacement door desires a particular door slab, but that particular door slab has characteristics that render it not particularly suitable for installation in the measured doorframe, the measurement device can utilize the measured data, compare it with characteristics of the identified proposed door slab, and notify the user that the particular door slab may be unsuitable for use in the measured doorframe. In some instances the measurement device can suggest similar door slabs which may be suitable for the measured doorframe. This capability is particularly useful for customer satisfaction so as to avoid this circumstance where a particular door slab may be selected, as selection relied upon, but at some point later the customer notified that the particular door slab selected will not be available due to unsuitability of the door slab. Furthermore, the measurement device may include particular marketing and availability data for individual door slab styles. For example if door slab a is desired by the customer yet that same door slab day may have a delivery delay from the manufacturer or distributor of the door slab of a particularly long time from the date of measurement, the customer can be notified at that time of the particular time frames relevant for delivery of that door slab. At such point, the measurement device can suggest alternate yet similar door slabs (such as from alternate suppliers) that may be available at more desirable time frames. This again can provide significant advantages in terms of customer satisfaction for the services associated with aspects of the present invention. It should be noted as well that in particular embodiments of the present invention the data relating to aspects, availability, price, tolerances, sizes and etc. of the door slabs can be held and analyzed in a device separate from the measuring device or in the measuring device. A variety of methods can be utilized to connect the other device with the measurement device to provide the type of checks and feedback to the customer discussed herein.

In some embodiments the measured data can be entered into a sales software program to show customers what the door product would look like in the application measured (with the correct dimensions of the actual doorframe used). The software can automatically render a displayed image to match the size of the doorframe measured. Additionally the rendering can be adjusted as needed for the sales presentation.

After the door measurement step 70, data relating to the door measurement can be processed 74. Processing can be done in the measurement device. Additionally in some embodiments of the present invention, electronic data relating to the measurement of the doorframe is transmitted to a central or other processing operation that calculates the precise cuts needed for the proposed door installation. In some embodiments the cutting information as well as identification of the particular door is sent to a CNC machining operation 76 which can either be local or remote from the processing system. In a related aspect of certain embodiments of the present invention, the central processing step 74 can serve also as a royalty tracking operation and step for entities using aspects of the present invention such as in either selling, measuring door frames, machining door slabs, painting, or installing doors.

In step 76 the CNC machine cuts the door slab to the precise measured shape of the doorframe, providing for a specified or automatically generated reveal between the door edges and the doorframe. Additionally hinge mortises, lock bore, latch mortise, as well as other cuts for other door or other desired hardware can be cut into the door slab. After CNC machining, in some embodiments the doors are painted 78. Thereafter, the custom cut and painted doors can be installed 80.

In some embodiments door slabs are not used. Instead custom-built doors or other devices are made using the measured and process data. In some embodiments, the measured data can be used to calculate the amount (such as square feet or number of units), or number of accessories required, or cost, and/or the pricing of particular products relating to the measured geometry. Such embodiments are particularly applicable in the sale of countertops or tile surfaces or the like.

In the measurement portion or process of certain embodiments of the present invention the following functions can be accomplished. First the frame can be measured. The hinge positioning can be measured. The latch position can be measured. The back set from the doorstop to the edge of the hinge can be measured.

In certain embodiments of the present invention the CNC machine can cut the hinge seating (or mortise) in the slab door. The door knob hole or bore can be cut. The latch hole can be cut in the door. The screw holes or starter holes for the screws for the hinge assembly can be drilled in the door slab in conjunction with the CNC operation.

In processing the electronic data relating to a particular door frame certain aspects of the present invention can also automatically calculate the amount of reveal that will exist between the door and the doorframe when the door is installed. Further, the system can compensate for the back set for the distance of the door from the doorstop to the edge of the hinge. Further, the system can adapt the cut to match the particular hinge design and hinge type that already exists in the doorframe. Further, the system can automatically insert the latch location in the cuts to be accomplished on the door.

The processing operation can also accommodate a customer preferences for change door thicknesses. For example if a customer desires to replace an existing door with a new door having a thicker or thinner thickness than the existing door, the thickness of the requested door, and in some cases that of the existing door, can be collected and input as appropriate. In the processing step the software can position the cuts for the hinge mortise in the appropriate position on the side of the (new thickness) door slab requested by the customer to accommodate a correct fit in the existing doorframe by the door having a new thickness. It should be noted that if a different thickness of door issues for the replacement door from that which existed in the original door, the location of the hinge mortise on the side of the replacement door must be changed from the location in the original door to accommodate the different thickness of the door so that the door when closed will still fit the doorframe and door stop in optimum fashion. In certain circumstances if the replacement door thickness desired is insufficiently thick for the particular hinge size or configuration being utilized the processing operations of the measurement device or the centralized processing operations can detect that there is insufficient space on the side of the door for the necessary space required by the hinge mortise. In such instances the user can be informed and the customer notified of the unsuitability of the particular door thickness.

Further embodiments can compare the calculated cuts for a particular door slab with data archives existing in the processing unit or associated with the processing unit which relate to the characteristics of the particular door slab anticipated to be cut. In some instances a particular customer may have selected a door style and accordingly a particular door slab for installation in a doorframe but the characteristics of the door may not tolerate the calculated cuts in the door. For example, the rails that form the perimeter of the door slab may be removed to too great a degree by the proposed cuts of the door slab to ensure the long-term stability of the door once installed. In contemplation of this, the systems of certain embodiments of the present invention compare the characteristics of the proposed door slab with that of the final cut and ensure that the proposed cuts would not adversely affect the stability of the particular door for installation. Accordingly, the processing systems of certain embodiments of the present invention can check the specifications and or certain pre-defined processing tolerances of a proposed door slab to ensure that the calculated cuts to the door slab are safe and appropriate for the proposed slab. In some embodiments the door slabs can have affixed to them bar codes which identify the precise model of each door slab. Additional bar codes may also be affixed which identify the precise door application for which the door slab is to be used (i.e. this barcoding would identify the unique cuts which are to be applied to the proposed door slab). When the door slab is input to the CNC machine for CNC processing and other check of the appropriate bar codes can be accomplished. In some embodiments the processing unit can generate an identifier barcode label that corresponds to the proposed cuts for a proposed door slab. Thereafter, the barcode can be affixed to the door slab to be cut. The barcode will serve as a check to the CNC machine to confirm that the model of door slab inserted into the CNC machine corresponds with the door slab contemplated during the processing step and also corresponds with a door slab which can receive the proposed machining by the CNC machine. Again, the bar labeling and identification of each door slab further provides a check for royalty tracking in use of aspects of the present invention.

In some embodiments operations associated with the CNC machine can also generate labels of particular use for installation of the doors. For example, special labels can be generated particularly adapted for use at installation. Such special labels can include not only bar codes but descriptions of the particular doorframe to which a particular cut door is to be installed. For example, a label can state “master bedroom entrance” indicating that the new door is to be installed at the doorframe at the entrance to the master bedroom, the master bedroom door frame. Such additional labels can greatly facilitate installation and reduce the skill level required the installation teams conducting the door installations. The data for the “common usage” labels (such as “master bedroom entrance” or “hallway bathroom entrance”) can be generated or collected by the measuring device operator and associated at the time of measurement with the data relating to the associated doorframes. The particular “common usage” labels can be associated with and attached to the uncut or cut door slabs in the machining or painting operations. Additionally the common usage labels can be attached to the doors after painting.

In some embodiments, such as franchised operations, the barcoding can be used as a check on royalty obligations and royalty compliance. The CNC machine can be operated by proprietary software that records the barcode of each door slab processed and transmits details of each door slab cut to a licensor.

Additionally, embodiments the present invention may serve to center the door slab within the proposed cuts of the door to ensure that once the custom cut door slab is installed in the doorframe that the features of the door are symmetrical in the installed position.

Certain embodiments of the present invention comprise novel process steps and capabilities in the measurement of the doorframe. In some embodiments a device is used to measure the doorframe which comprises an assembly which is positioned adjacent to a doorframe. An operator can extend a pointer of the measurement device to certain positions on the doorframe. When the pointer of the measurement device is extended to certain positions of the doorframe, the operator can signal the measurement device to record the position of the pointer device. The measurement device can record the relative position in space of the measured point with the other points measured and, in some cases, with the position of the measuring device. These positions can include the bottom of one side of the frame, the middle of the frame, the top of the side of the frame, the top of the other side of the frame the middle of the other side of the frame in the bottom of the other side of the frame. Additional positions to be measured can include the latch hole in the doorframe and the positions of the hinges. In some embodiments the positions of the hinges are measured accurately by applying the pointer device to the center of the screws in the hinge assembly. Once the pointer device is positioned at the center the screws the operator signals the measurement device to record the position of the pointer device. By this means the measurement device can accurately measure in space positions along each side and the top of the doorframe as well as the precise positions in the doorframe of the latch hole in the hinges. Additionally, any number of custom positions along the doorframe can be selected or preselected for measurement. Further, in some embodiments, the measurement pointer device can be moved continuously along a surface of the doorframe and a complementary continuous set of data points can be collected in the measurement device representing the continuous measured points along the surface of the doorframe.

In some embodiments, the measuring device can be programmed to prompt the operator to re-measure certain already measured points in the event that preliminary calculations in the measuring device suggest that an error may have occurred in a prior measurement.

Additional measurements can measure the positions of door closing devices in the doorframe or on the door, the position of deadbolts, security latches, peepholes, locations of security alarm sensor devices (on the doorframe), as well as other devices.

In some embodiments, the measurement device provides for the manual entry of the type of flooring existing in the doorframe. For example carpet, or hardwoods, or some other surface may exist in the doorframe. The processing equipment of embodiments of the present invention can adjust the bottom cut of the door slab to provide appropriate clearance for the particular flooring that exists at the doorframe. In certain embodiments of the present invention the measurement device prompts the operator to input certain data such as precise locations in the doorframe to be measured, the flooring type, the type of hinge existing on the door frame as well as other data.

There are several types of standard hinges in use. The operator of the measurement device can input the identification of the type of hinge existing on the doorframe. The processing unit uses the identification of the type of hinge to dictate the type of hinge cut that is put in the door slab so that the finished door slab will have a hinge cut that precisely matches the actual hinge of the doorframe.

In addition, in some embodiments the processing unit can angle the hinge cut to enable the door to close more easily.

In other embodiments the processing unit can dictate either a single bevel or a double bevel on the sides of the door to assist in door closing. In some instances a 30 bevel on the latch side and/or the hinge side is cut.

In some embodiments the processing unit can account for local humidity and climate effects on the materials of the particular door slab proposed for particular installation. These humidity and climate effects are taken into account in dictating the cuts to be made to the door slab so that the reveal that will exist when the door is installed will be appropriate regardless of the particular humidity or climate of the season.

As used herein, the “reveal” between a door and a doorframe is intended to mean the distance between the edge of the door and the corresponding edge of the doorframe that aligns with the door. In some instances, a small gap or “reveal” is desired. In other senses, a relatively large gap or “reveal” is desired. In some instances the amount of “reveal” can be optimized to suit the particular conditions of the door being replaced. For example, if the doorframe and/or replacement door material is particularly prone to swelling due to humidity and if the doorframe and or replacement door is going to be exposed to humidity after installed, a reveal allowing for the anticipated swelling of the doorframe and or the door can be calculated into the cuts applied to the door slab or door. This is of particular value in avoiding a circumstance where due to swelling the replacement door will no longer close into the doorframe opening. The various components of the present methods can additionally note or receive input indicating the environment associated with the door to be replaced. For example, data can be collected, or automatically input, to show whether the replacement door will be in an environment subject to changes in humidity. For example if the door is to be installed in a house in a geographical region that has seasonal changes in humidity, appropriate calculations can be made in the reveal to accommodate the anticipated changes in the size of the doorframe and or the door to accommodate these changes. Additionally, in some instances while the replacement door is to be installed in a geographical location that has substantial humidity changes, if the replacement door is to be inside a structure (such as a house or office) that has continuous conditioning of the air inside the structure, this data can be noted and utilized and appropriate accommodations made in the calculated cut of the reveal to accommodate a conclusion that while high humidity does occur, the conditioning of the air in the replacement door environment is such that the reveal can be cut on the door as if humidity will not be a particular factor. Additionally data can be collected in at different steps in the operation to indicate the humidity exposure of the particular material being cut. For example, if door slabs to be cut are stored in an environment exposed to humidity, the door slabs may swell prior to cutting. If these same swollen doors are cut and then installed in an environment which does not have significant humidity (such as in a humidity controlled environment or a region of the country which does not have significant humidity), appropriate accommodations must be made in the calculation of the proposed cuts of the door slab to accommodate the other swelling of the wood (or other material) of the door in the installed environment. For example, if a door prior to CNC machining is exposed to humidity and is accordingly swollen, the CNC machining should be accomplished in such a way such that the newly machined door will actually be larger than the door will ultimately be in the non-humid installed location of the door. Alternatively, if the door prior to CNC machining is substantially not exposed to humidity, but will be exposed to humidity in its installed condition, the door should be cut relatively undersized for the intended doorframe so that when installed and subjected to humid conditions, the door will fit the doorframe with the desired reveal.

In some embodiments the processing unit can design cuts to the door slabs so as to provide an equal reveal around the exterior of the door in juxtaposition of the frame. It should be noted that this is a novel advantage of the present invention. Prior art systems that simply measured the existing door and used that as a template for the new replacement door would simply generate a replacement door that had the same reveal as the old door. However the old door may have had an undesirable reveal. For example, if the doorframe bowed outwards and the old door was straight the old door system would have had a reveal that varied in distance along the length of the door edge. Embodiments of the present invention that particularly note the irregularities in the dimensions of the doorframe can cut the door to correspond to these irregularities to provide an optically pleasing and consistent reveal along the entire edge or periphery of the door.

Aspects of the present invention are applicable to interior and exterior door replacement as well as to doors constructed of a variety of materials.

In some embodiments the measurements of the doorframe are taken at the front or the outside of the frame as compared to the inner portion of the doorframe adjacent the door stop. In such an embodiment, greater assurance is provided that the reveal existing when the door it is installed will be appropriate and provide a more pleasing visible effect than might otherwise be the case.

In certain embodiments the processing unit can also use the measured doorframe data to design cuts for custom casing to be installed around the doorframe. The processing unit can design custom cuts at the joints of the casing to provide maximum long time fit, cosmetic effects, and ease of installation. Such custom cuts at the joints can include tongue and groove and similar type features. Portions of these aspects of the present invention are particularly useful to capture the differing lengths of different portions of the door frame and the exact angle of the top corners of the doorframe (which frequently do not equal the optimum 90 degree angle).

In some embodiments, if desired, the processing unit can calculate the positioning in the appropriate cuts for the addition of a third hinge to a door frame and door. This may be an appropriate design step if the proposed new door is calculated by the processing unit as being too heavy for the application and original set of two hinges. Embodiments of the present invention can automatically calculate and take into account this effect. In some embodiments the third hinge location could be entered manually. In other embodiments the third hinge position could be automatically input.

In some embodiments the measuring device can also include operator software to ensure the integrity of measurements taken in decisions made at the site of the doorframe. In some embodiments, an individual can select a particular style of door for a proposed installation. The operator can input the style of door in the measurement device and the device can indicate certain measurements which may be unique to the particular style of door which should also be taken when measuring the doorframe, hinges, latch assembly or other details. Further, the measurement device can alert the operator if measurements taken at the doorframe indicate that a proposed door style will not fit the doorframe as measured. This can enable the operator to work with the individual selecting the door style at the time of measurement to select a different door style that would be physically recommended for the measured doorframe.

In the instance of double swing doors, certain embodiments of the present invention are also applicable. In some embodiments the measurement device captures the dimensions of the entire opening for the two doors and then the system creates to separate door files for the cutting of the doors for the opening. The two doors' strike plates and latch meeting position is calculated and correctly positioned on each door. In the instance of styled doors, it is important in many cases that the panels match vertically and also that they be symmetrically oriented horizontally. Embodiments of the present invention can insure that such symmetrical considerations are checked and designed into the cuts for the particular doors. Stored data relating to the specifications of the proposed doors is used in custom designing an orienting (such as in the processing step) the styled or other doors in such applications.

In some embodiments for double doors the systems of the present invention can also calculate and account for the use of an astragal between the doors and still provide a precise fit of the doors and a symmetrical appearance of the doors. In some implementations, the astragal becomes integral with the door portion to which it is attached so that the total width of the finished door includes the width of the astragal portion that abuts the edge of the adjoining double door. Accordingly, the actual cut door slab of the door receiving the astragal would be smaller in width than the width of the matching double door by the width of the astragal to be attached to the receiving door. Calculations to accommodate for this are made in the processing steps.

In some embodiments during the measurement process it may be advisable to measure the top and bottom or other positions of the hinge assembly as compared to the center of the screw holes. In some instances this may be necessary as paint or other materials may actually have covered the location of the screw holes. In some embodiments the measurement probe can actually be traveled along the periphery of the hinge plate so that the measurement itself can automatically identify the type and size of the hinge on the doorframe. In some embodiments a measurement by the probe can be taken against the doorstop and at the edge of the hinge adjacent the doorstop to program into the system the back set of the hinge. In some embodiments the measurement probe can measure the arch top of arched doors. The probe can be traveled along the length of the arch. In some embodiments of the probe can be positioned at certain spots along the arch.

In some embodiments the probe design can be configured to have a pressure sensitive tip so that a measurement is taken at the time that the probe is “pressed” against a surface. In some embodiments the probe may have a “thumb button” or other button by which an operator can signal when a measurement is to be taken. In some embodiments a separate controller can be used by which the operator signals that a particular point is to be measured.

In some embodiments these systems can provide a check of previous data with the correlation of new data indoor measurements. For example, if a first pass of measurements measures the frame of the door and a second pass of measurements measures the latch and hinge locations, the systems can check to ensure that there is accurate correlation between the measured points. If there is not sufficiently accurate correlation the system can alert the operator to remeasure certain components of the frame opening. For example, if the second pass measurement of the hinge location shows a location not in the line measured for the hinge side of the door frame, the system can indicate an error and request remeasurement of either or both of the side of the door frame and the hinge location. Additionally, remeasurement of the entire door frame can be requested. In some embodiments, such as when critically expensive doors are to be used, the system may prompt the user to measure all or some of the points of the door opening a second time just to ensure the reliability of the data measurements. Thereafter the second set of measurements can be compared with the first and a threshold accuracy desirably reached before prompting the operator to finish the measurements. If the threshold is not reached, a third set or more of measurements may be dictated.

In some embodiments the device can alert the operator if a standard door or a proposed door slab does not fit the measured data of the door opening. The system can alert the operator to choose another door product or to take some other action.

FIG. 4 shows an embodiment of the present invention wherein a measuring device 52 is positioned in the swing area 90 of the doorframe. In certain embodiments of the present invention is preferred that the measuring device 50 to be positioned in the swing area 90 of the doorframe to facilitate optimum measurements of the doorframe, hinge locations, and other dimensions of the doorframe.

FIG. 5 shows aspects of the present invention including an apparatus of particular application with various methods described herein. Shown is a card 100 that can be used by an operator of the measurement device. The card can be manufactured from plastic or other suitable material. The card has a shape shown generally as in FIG. 5 and also includes cutouts shown at 102. The card also includes rounded edges 114 and 112. The card 100 can be used in measuring steps by the operator. In one step the operator can lay the curved edges 114 and 112 over the hinge assembly of the doorframe to be measured. Since hinge assemblies typically either have a ¼″ radius or eight ⅝″ radius, by laying the card over the hinge assembly the operator can match and identify whether the measured change has either a ¼″ curve or a ⅝″ curve by a reading on the card 100 whether the matched curve radius is either ¼″ or ⅝″ curve. The measured and identified curve radius can be input to the measure in the device or otherwise recorded for calculations in the processing steps. Additionally at 110 is shown a series of depths measurements by aligning the top portion of the card 120 with one edge surface of the door and checking the alignment of indicators at 110 the operator can identify whether the existing door is 1⅜, or 1¾, or 2 inches in thickness. This data can also be recorded or input into the measurement device. The cutouts at 102 are particularly useful for determining the amount of back set between the existing hinge in the doorframe and the doorstop of the doorframe. In utilizing the card 100 in determining the back set, the user can position the card 100 on the surface of the doorframe and position edge 106 adjacent the doorstop. Looking into the gaps or cutouts 102 the operator can determine which cut out 102 aligns over the edge of the hinge plate of the doorframe. The corresponding number (such as 1, 2, 3, . . . 7) shown on the card adjacent to cutouts 102 can be input into the measured the device or otherwise recorded for later processing in the processing steps. The distance 104 between the edge 108 of the cutouts 102 and the edge 106 of the card can be of a variety of thicknesses. The card 100 also includes an indicator to assist the operator to identify whether the door is a left swing or a right swing door. When the card is positioned on the surface of the doorframe with surface 106 abutting the doorstop, if the indicator “left swing” is on top, the operator will know that the door is a left swing door. If the indicator right swing is on top the operator will know that the door is a right swing door. This data can then be recorded or input into the measuring device.

Aspects of the present invention provide systems and methods whereby, without skilled carpentry work, and without removing any door jams or door casing, an operator can measure a door and approximately less than a minute. New doors can be cut from slabs to fit precisely to the actual door opening. Further, the CNC machine can machine each door to fit the needs of the proposed application-including machining in the hinge mortises, lock bore, and latch mortise, as well as any undercut for throw rugs or thresholds that might be in the footprint swept by the door in its normal travel.

According to aspects of certain embodiments of the present invention, data is collected as to the relevant positions a certain points on a doorframe. Such relevant points may include points along the sides and or top of the doorframe. Such relevant points may also include the location of components of the hinge assembly on the doorframe. The data collected is processed to generate a proposed plan of machining of a pre-manufactured door slab. Thereafter the door slab is machined according to the generated proposed plan and reduced in size according to the plan. The thus reduced in size door slab is optimally configured for installation in the measured doorframe. Particular points of novelty include the fact that the steps here in include measurement of the doorframe rather than measurement of a pre-existing door and also comprise the removal of access material from an existing door slab to fit a measured doorframe.

According to aspects of certain other embodiments of the present invention the data collected as to any existing doorframe is used, alternatively, to build a new door in additive function rather than to remove material from an existing door slab. In some embodiments, such as when a double door is replaced with a single door, the methods of the current invention can be used to calculate design sizes of sidelight panels or side panels adjacent a new door to be prepared such that the existing doorway which had previously accommodated two doors will now receive a single door with one or two side panels or side lights. In some embodiments a new door can be built by utilizing prebuilt door components such as windows or internal panel portions or other portions and the processing systems calculating the dimensions of additional side rail portions of the door that will mate with the existing prebuilt portions. In some instances, the additional side or top rail portions can be prebuilt, but then cut down according to instructions from the processing system to result in rail portions that can thereafter be combined with the pre-existing components to arrive at an optimally sized custom door.

It should be understood that aspects of the present invention are applicable as well to replacement of cabinet doors, countertops and other items for which custom measurement is needed or useful.

Various alteration, additions and/or modifications may be made to the parts previously described without departing from the ambit of the present invention.

1. A method of providing replacement doors for an existing door frame, comprising:
determining dimensions of the door frame corresponding to the portions facing a door once installed;
determining the location in relation to determined dimensions of the door frame of at least one hinge assembly on the door frame;
cutting at least one edge of a door assembly to correspond to the determined dimensions of the door frame.

2. A method replacing a door, comprising:
recording relative positions in space of a plurality of points on an interior surface of the strike side of a doorframe;
recording the relative positions in space of a plurality of points on an interior surface of the hinge side of a doorframe;
recording the relative positions in space of a plurality of points representing an interior surface of the top of the doorframe;
processing data representing at least a plurality of the recorded positions to formulate a representation of interior surfaces of the doorframe;
determining a reveal around at least a portion of the represented interior surfaces; and
defining a peripheral shape for a replacement door to be positioned in the doorframe and having a shape that substantially provides the determined reveal when the door is finally positioned in the doorframe.

3. The method of claim 1, wherein the relative positions of points are relative to an orientation point of a measuring device.

4. The method of claim 1, further comprising utilizing data relating to the defined peripheral shape to manufacture a replacement door that substantially provides the determined reveal when the door is finally positioned in the doorframe.

5. The method of claim 1, further comprising:
recording the relative position of at least one hinge on the doorframe; and
processing the relative position of the at least one hinge to define a position of the hinge in juxtaposition to the representation of at least one interior surface of the doorframe.

6. The method of claim 5, further comprising:
utilizing data relating to the juxtaposed position of the hinge to form a hinge mortisse on the manufactured door complimentary to the at least one hinge on the doorframe.

7. The method of claim 6, wherein when the at least one hinge is positioned in the formed hinge mortisse the determined reveal is substantially preserved between the door and the doorframe.

8. The method of claim 5, wherein the relative position of at least two hinges on the doorframe are recorded and a hinge mortise for each of the hinges is formed on the manufactured door.

9. The method of claim 4, wherein the door is manufactured by trimming material from at least one edge of a door slab.

10. The method of claim 4, wherein the door is manufactured by assembling components of a door to form a door generally corresponding to the defined peripheral shape.

11. The method of claim 1, wherein at least one portion of the representation of one interior surface of the doorframe is bowed and the defined peripheral shape of the edge of the door corresponding to the bowed portion is correspondingly bowed to provide a generally consistent reveal between the respective surface and edge when the door is finally positioned in the doorframe.

12. A method of replacing a door, comprising:
recording the positions of a plurality of points on an interior surface of the strike side of a doorframe;
recording the positions of a plurality of points on an interior surface of the hinge side of a doorframe;
recording the positions of a plurality of points representing an interior surface of the top of the doorframe;
processing data representing at least a plurality of the recorded positions to formulate a representation of interior surfaces of the doorframe;
utilizing data from the representation to drive a device to cut the edges of a door slab to form a replacement door that corresponds to the representation; and
installing the replacement door in the doorframe.

13. The method of claim 12, further comprising:
recording the position of at least one hinge on the doorframe;
processing the recorded hinge position to produce a representation of the position of the hinge; and
utilizing the represented position of the hinge to drive a device to form a hinge mortisse in the replacement door, the hinge mortisse positioned to accommodate attaching the hinge to the door in the hinge mortisse and so that the door fits in the doorframe.

14. The method of claim 13, further comprising:
defining the back set from the door stop to the edge of the at least one hinge; and
determining the position of the mortisse to be formed on the replacement door so as to provide a predetermined back set from the replacement door to the door stop when the replacement door is attached to the hinge.

15. A method of forming a replacement door, comprising:
recording positions along the interior surface of a doorframe, the position of at least one hinge on the doorframe, and the position of the latch hole in the doorframe;
utilizing at least some of the recorded positions to determine the peripheral shape of a replacement door;
utilizing at least one of the recorded positions to determine the position of a hinge mortisse on the replacement door corresponding to the position of the at least one hinge;
utilizing at least one of the recorded positions to determine the position of a latch bore on the replacement door corresponding to the position of the latch hole;
utilizing the determined peripheral shape to command a device to trim a door slab to form a replacement door;
utilizing the determined position of the hinge mortisse to command a device to form a corresponding hinge mortisse in the replacement door; and
utilizing the determined position of the latch bore to command a device to form a latch bore in the replacement door.

16. The method of claim 15, further comprising mounting the replacement door in the door frame.

17. The method of claim 15, further comprising:
conducting a check on data relating to the recorded data for the doorframe, hinge and latch hole to insure that the recorded data reflect that the position recorded for the hinge corresponds to a position on the doorframe and the position recorded for the latch hole corresponds to a position on the doorframe.

18. The method of claim 17, wherein the check is conducted in conjunction with the steps of recording the positions.

19. The method of claim 18, wherein when the recorded position of the hinge or the latch hole is not within a predetermined distance from the recorded position of the doorframe surface, an alert is issued and the positions of at least one of the doorframe surface, the hinge position or the latch hole position is recorded a second time and a second check is conducted of the later recorded positions.

20. The method of claim 15, wherein at approximately the time of recording the data for the doorframe a check is conducted utilizing the recorded data for the doorframe against the size specifications of a door slab type proposed for forming a replacement door for the doorframe.

21. The method of claim 15, wherein the back set from the hinge to the doorstop of the door frame is processed in conjunction with the recorded data for the doorframe and the hinge to determine a position of the hinge mortisse on the trimmed replacement door that results in a predetermined back set between the replacement door, once installed, and the door stop on the hinge side of the door frame.

22. The method of claim 15, further comprising:
generally contemporaneously with recording the position of the at least one hinge, identifying a hinge type for the hinge from a selection of hinge types; and
utilizing data relating to the identified hinge type to command a device to form a hinge mortisse corresponding to the identified hinge type in the replacement door.

23. The method of claim 15, further comprising:
selecting components for attachment to the replacement door, from a group of components having varying dimensions; and
utilizing dimension data relating to the selected components to prepare instructions to a cutting device, transferring the instructions to the cutting device, utilizing the cutting device to cut receiving portions in the replacement door to receive the selected components.

24. A method of preparing casing for a door frame, comprising:
recording positions along the interior surface of a doorframe;
utilizing at least some of the recorded positions to determine dimensions for customized casing segments for each of the side and top portions of the door frame;
utilizing at least one of the recorded positions to determine the angle of matching and joining cuts on each of the top and side casing segments;
utilizing the determined dimensions and the determined angle to prepare instructions to a cutting device to cut the side and top casing segments having the determined dimensions and angles as well as mutually overlapping stability portions; and
utilizing the instructions at the cutting device to cut the side and top casing segments having the determined dimensions and angles as well as mutually overlapping stability portions.
